(19) United States
(12) Patent Application Publication
(10) Pub. No.: US 2016/0073015 A1
(43) Pub. Date: Mar. 10, 2016

(54) IMPLEMENTING AN AUTOMATED CAMERA SETTING APPLICATION FOR CAPTURING A PLURALITY OF IMAGES

(71) Applicant: Anne Elizabeth Bressler, Redmond, OR (US)

(72) Inventor: Anne Elizabeth Bressler, Redmond, OR (US)

(21) Appl. No.: 14/837,637

(22) Filed: Aug. 27, 2015

Related U.S. Application Data
(60) Provisional application No. 62/070,784, filed on Sep. 6, 2014.

(51) Int. Cl. H04N 5/232

(52) U.S. Cl. CPC H04N 5/23225; H04N 5/23296

(57) ABSTRACT

The present invention relates to implementing an automated camera setting application while capturing a plurality of image(s)/image frame(s). The application allows the user(s) to set the zooming range, along with the zooming option for the image(s)/image frame(s), which is applied while the image(s)/image frame(s) are captured through the application. Further, the application allows the user(s) to set the timing and the number of image(s)/image frame(s) to be captured by the application.

### FIELD OF THE INVENTION

The present invention generally relates to implementing an automated camera setting application and more particularly relates to automatically applying the camera setting while capturing a plurality of images/image frames from an image capturing device.

### BACKGROUND OF THE INVENTION

The existing image capturing device allows the user to manually set the camera zooming range and option(s) while capturing the images. Also, the existing device allows the user to capture multiple images/frames based on the time interval setting specified by the user. However, the existing image capturing device requires manual intervention to specify the zoom setting options to be applied while capturing multiple images/frames. At times, it is required to capture multiple images/frames with different zoom setting options applied to different images/image frames.

Hence, there is a need for an application that can automatically apply the camera setting while capturing multiple images / image frames through an image capturing device.

### SUMMARY OF THE INVENTION

The present invention relates to implementing an automated camera setting application while capturing a plurality of images/image frames from an image capturing device, wherein the application comprises of a means to set the zooming range along with the zoom-in and zoom-out option(s). Further, the application provides a means to set the number of images to be captured, along with the timing set for the image frame(s) while capturing the plurality of images/image frames.

### BRIEF DESCRIPTION OF DRAWINGS

FIG. 1 illustrates a working overview of the system 100 implementing an automated camera setting application 102 for capturing a plurality of images/image frames through an image capturing device 103.

FIG. 2 illustrates a flow-chart 200 that explains the process of automating the camera setting application 102 for capturing a plurality of images/image frames through an image capturing device 103.

FIG. 3 illustrates a system overview of components 300 used to implement the process of automating the camera setting application 102 for capturing a plurality of images/image frames through an image capturing device 103.

### FIGURE DESCRIPTION

100—A system overview
101—A network within which an automated camera setting application is implemented
102—A camera setting application configured to capture images
103—An image capturing device
104—A repository of captured images
200—A process explaining the working of an automated camera setting application
300—A system overview of components used for implementing an automated camera setting application
301—An Application module
302—A Configuration module
303—A Processing module
304—A Storage module
305—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term image capturing device 103 refers to a device that can be used for launching a camera setting application 102, which allows the user to specify the image/image frame setting options. For example, the image capturing device 103 can be a smart phone, a mobile phone, a laptop, a tablet, a personal computer, or the like.

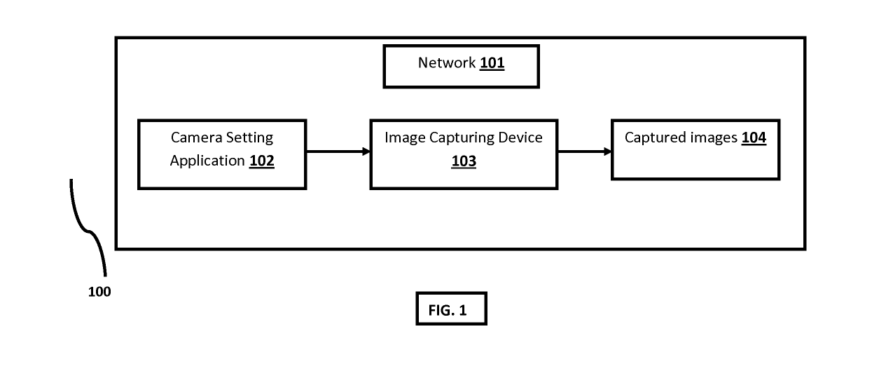

Referring to FIG. 1 illustrates a working overview of the system 100 implementing an automated camera setting application 102 for capturing a plurality of images/image frames through an image capturing device 103. As depicted in the figure, the camera setting application 102 is launched in an image capturing device 103 and the application 102 allows the user to set the zooming range and the zoom-in/zoom-out options for a plurality of images/image frames that are to be captured. In an embodiment, the zooming range, zoom-in/zoom-out options set through the camera setting application 102 is commonly referred to as image capture setting. Further, the application 102 allows the user to specify the number of images/frames to be captured along with the time interval set for the captured images/image frames. In an embodiment, as the image capturing device 103 captures the images/image frames, the application 102 automatically applies the zooming range and the zoom-in/zoom-out options set for the plurality of images that are to be captured. The image capturing device 103 is configured to automatically pause capturing the images/frames while the application 102 employs the zooming range and the zoom-in/zoom-out option specified for the images/image frames. Based on the number of images to be captured, along with the frame timing, the application 102 continues to automatically apply the zoom settings specified by the user through the application 102. In an embodiment, as the application 102 completes capturing the images/image frames based on the image capturing settings specified by the user, the captured images 104 are stored in the repository of the image capturing device 103.

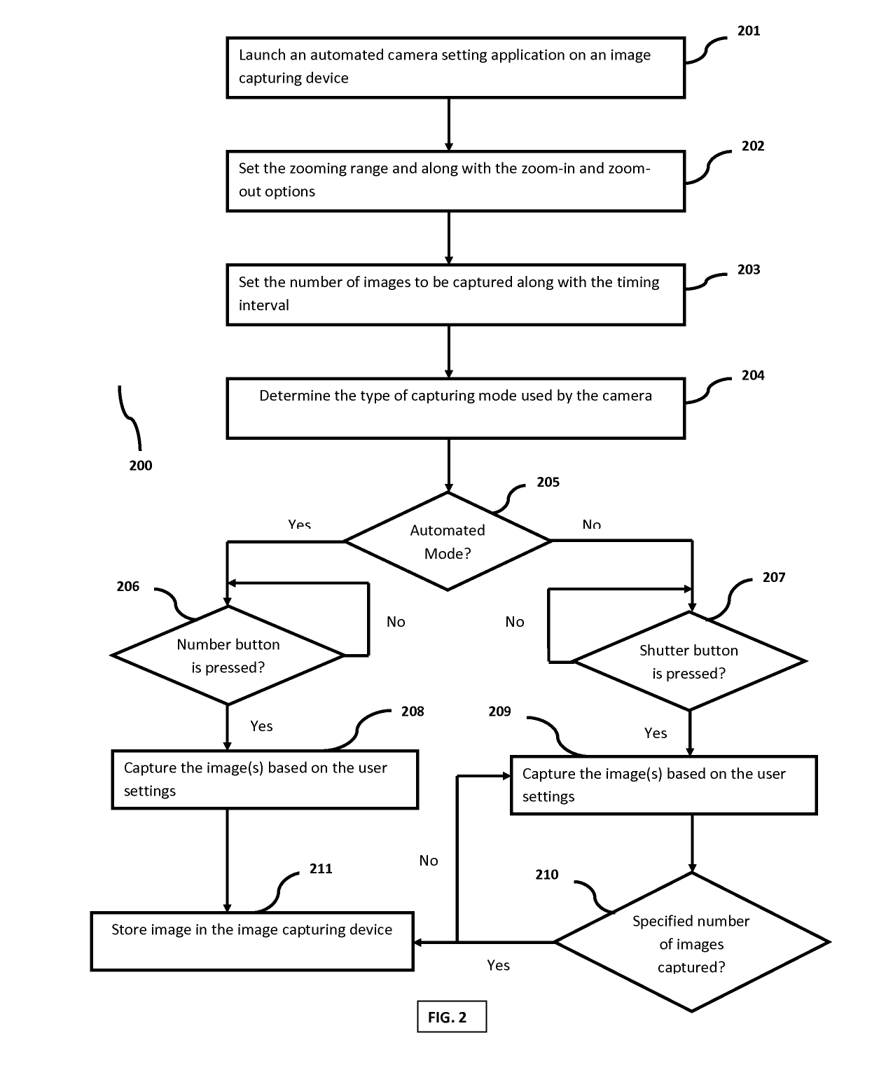

Referring to FIG. 2 illustrates a flow-chart 200 that explains the process of automating the camera setting application 102 for capturing a plurality of images/image frames through an image capturing device 103. Initially, at step 201, the method 200 allows the user to launch the camera setting application 102 in an image capturing device 103. In an embodiment, as the camera setting application 102 is successfully launched in the image capturing device 103, at step 202, the method 200 allows the user to set the zooming range and options for the plurality of images/image frames that are to be captured by the application 102. Further, at step 203, the method 200 allows the user to set the number of images to be captured along with the timing interval associated with each of the captured images/image frames. Further, at step 204, the method 200 determines the type of operation mode set for the image capturing device 103, wherein the image capturing device 103 can be set to operate either in the automated mode or in the manual mode. At step 205, if the method 200 determines that the image capturing device 103 is set to operate in an automated mode then at step 206, the method 200 automatically determines the number button that is set/pressed for capturing the image/image frames. However, if the method 200 determines that the image capturing device 103 is set to operate in a manual mode then at step 207, the method 200 allows the user to manually press the shutter button of the image capturing device 103 to capture the image(s)/image frame(s). As the user manually presses the shutter button of the image capturing device 103, the method 200 applies the image capturing settings such as the zooming range and options for the plurality of image(s)/image image frame(s) while the user captures the image(s)/frames(s). While the method 200 determines that the image capturing device 103 is set to operate in an automated mode/manual mode then at steps 208, 209 the method 200 applies the image capturing settings while capturing the image(s)/image frame(s). Further, at step 210, the method 200 determines the number of image(s)/image frame(s) to be captured by the image capturing device 103. If the image capturing device 103 has captured the specified number of image(s)/image frame(s) then the method 200 stores the captured image(s)/image frame(s) in the image capturing device 103. Otherwise, the method 200 continues to capture the image(s)/image frame(s) by automatically applying the settings until the specified number of image(s)/image frame(s) are captured by the image capturing device 103.

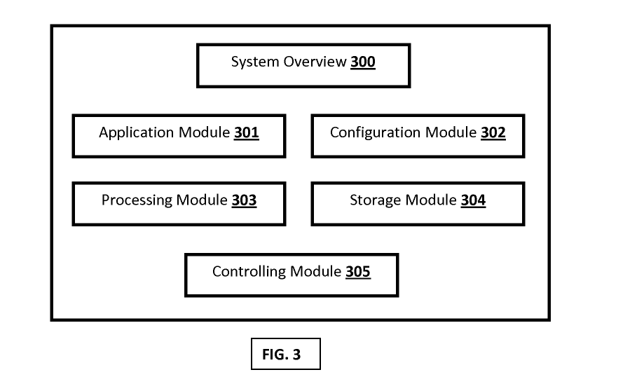

Referring to FIG. 3 illustrates a system overview of components 300 used to implement the process of automating the camera setting application 102 for capturing a plurality of images through an image capturing device 103. In an embodiment, the system 100 comprises of an Application module 301, a Configuration module 302, a Processing module 303, a Storage module 304, and a Controlling module 305. The Application module 301 is configured to launch the camera setting application 102 in an image capturing device 103. The Configuration module 302 is configured to allow the user(s) to specify the image capturing settings that will be applied by the application 102 while the image(s)/image frame(s) are captured through the image capturing device 103. The Processing module 303 is configured to process the image capturing settings specified by the user that will be applied to the image(s)/image frame(s) captured by the application 102. The Storage module 304 is configured to store the image(s)/image frame(s) that are captured by the image capturing device 103 after applying the image capturing settings through the application 102. The Controlling module 305 is configured to transfer data across various modules required for implementing the camera setting application 102.

1. An automated camera setting application for capturing a plurality of images/image frames from an image capturing device, wherein said application comprises of:
a means to set at least one zooming range along with zoom-in and zoom-out option, commonly referred to as a camera setting, to be applied to said plurality of images/image frames;
a means to set the number of images/image frames to be captured; and
a means to set the timing while capturing said plurality of images/image frames.

2. The application as claimed in claim 1, wherein said application is configured to incrementally pause while capturing the plurality of images/image frames based on the timing set for capturing said plurality of images/image frames and the number of images/image frames set to be captured while automatically applying the camera setting.

3. The application as claimed in claim 2, wherein said application is configured to automatically apply said at least one zooming range with zoom-in and zoom-out option that is set for capturing said plurality of images/image frames while the application incrementally pauses to capture said plurality of images/image frames.

4. The application as claimed in claim 1, wherein said application is configured to automatically stop capturing the plurality of images based on the number of images/image frames set by the user.

5. The application as claimed in claim 1, wherein said application is configured to apply the camera setting while the camera is set to work either in an automated mode or in a manual mode.

6. The application as claimed in claim 1, wherein said application is configured to work on any platform.

7. A computer program product comprising computer executable program code recorded on a computer readable non-transitory storage medium, said computer executable program code when executed, causing the actions including:
setting at least one zooming range, along with zoom-in and zoom-out option, commonly referred to as camera setting, to be applied automatically to said plurality of images/image frames that is being captured by an automated camera setting application;
setting the number of images/image frames to be captured by said automated camera setting application; and
setting the timing for capturing said plurality of images/image frames by said automated camera setting application.

8. The computer program product as claimed in claim 7, wherein said application is configured to incrementally pause while capturing the plurality of images/image frames based on the timing set for capturing said plurality of images/image frames and the number of images/image frames set to be captured while automatically applying the camera setting.

9. The computer program product as claimed in claim 7, wherein said application is configured to automatically stop capturing the plurality of images/image frames based on the number of images/image frames set by the user to be captured through the application.

10. The computer program product as claimed in claim 7, wherein said application is configured to automatically apply the camera setting while the camera is set to work either in an automated mode or in a manual mode.

11. The computer program product as claimed in claim 7, wherein said application is configured to work on any platform.
